(19) United States
(12) Patent Application Publication
(10) Pub. No.: US 2011/0288674 A1
(43) Pub. Date: Nov. 24, 2011

(54) APPARATUS FOR MANAGING A HOLDER, APPARATUS FOR MANUFACTURING A LAYERED SEMICONDUCTOR AND METHOD FOR MANAGING A HOLDER

(76) Inventors: Isao Sugaya, Kawasaki-shi (JP); Satoru Sanada, Chigasaki-shi (JP); Hidehiro Maeda, Yokohama-shi (JP); Masahiro Yoshihashi, Abiko-shi (JP); Mikio Ushijima, Chofu-shi (JP)

(21) Appl. No.: 13/112,719

(22) Filed: May 20, 2011

Related U.S. Application Data
(63) Continuation of application No. PCT/JP2009/006294, filed on Nov. 20, 2009.

(30) Foreign Application Priority Data
Nov. 21, 2008 (JP) 2008-298603

(51) Int. Cl. G06F 17/00; B23Q 7/00; B23Q 3/00

(52) U.S. Cl. 700/110; 269/289 R; 29/559

(57) ABSTRACT

Management of the holding member that holds the semiconductor substrate is efficiently implemented. Provided is a holding member management apparatus that manages a substrate holding member that holds a semiconductor substrate in a manufacturing apparatus that manufactures a stacked semiconductor apparatus by joining a plurality of semiconductor substrates; comprising a history storing part that stores the usage history of the substrate holding member in association with identification information that specifies the substrate holding member and a holding member specifying part that specifies and outputs identification information of the substrate holding member whose usage is to be suspended based on the usage history stored in the history storing part.

### BACKGROUND

1. Technical Field

The present invention relates to a holding member management apparatus, which manages a substrate holding member that holds a semiconductor substrate, a stacked semiconductor manufacturing apparatus, which comprises said holding member management apparatus, and a holding member management method, which manages said substrate holding member.

2. Related Art

Known are bonding apparatuses that, in a status in which a pair of wafer holders that hold wafers has been superposed, bond together the pair of wafers by subjecting the pair of wafers to pressure application and heating along with the pair of wafer holders (for example, see Patent Document 1). Provided on the wafer holders are magnets and magnetic bodies, which chuck the wafer holders, and leaf springs, etc. that regulate chucking between these magnets and magnetic bodies.
Patent Document 1: Japanese Unexamined Patent Application Publication No. 2007-208031

In the above bonding apparatus, it is thought that the magnetic force of the magnets, the elastic force of the leaf springs and the flatness of the wafer holders will decrease due to the heat and pressure applied to the wafer holders. In addition, it is thought that a drop in the quality of the components comprised by the wafer holders and that of the wafer holders themselves would affect the accuracy of alignment adjustment of the wafers.

### SUMMARY

The aforementioned problems are to be solved, and provided as the first mode of the present invention is a holding member management apparatus, which manages a substrate holding member that holds a semiconductor substrate; comprising a holding member specifying part, which specifies and outputs the substrate holding member whose usage is to be suspended.

In addition, provided as the second mode of the present invention is a stacked semiconductor manufacturing apparatus; comprising a joining apparatus, which joins the semiconductor substrates held by the substrate holding member, the aforementioned holding member management apparatus, and a holding member supplying part, which supplies a substrate holding member other than a substrate holding member identified by means of identification information output from the holding member specifying part to the joining apparatus.

Also, provided as the third mode of the present invention is a holding member management method, which manages a substrate holding member that holds a semiconductor substrate; comprising a holding member specifying stage, which specifies and outputs the substrate holding member whose usage is to be suspended.

Note that the above outline of the invention does not enumerate all of the special characteristics of the invention. In addition, sub-combination of groups of these special characteristics may also result in the invention.

### BRIEF DESCRIPTION OF THE DRAWINGS

FIG. 1 is a plan view that schematically shows the overall structure of a bonding apparatus 100.

FIG. 2 is a cross-sectional view that schematically shows the structure of an alignment apparatus 140 alone.

FIG. 3 is a drawing that shows operation of the alignment apparatus 140.

FIG. 4 is a perspective view that shows a status in which a wafer holder WH is seen from above.

FIG. 5 is a perspective view that shows a status in which the wafer holder WH is seen from below.

FIG. 6 is a perspective view that shows a status in which the wafer holder WH is seen from above.

FIG. 7 is a perspective view that shows a status in which the wafer holder WH is seen from below.

FIG. 8 is a side cross-sectional view that shows that shows an enlargement of a chucking part 950.

FIG. 9 is a side cross-sectional view that shows an enlargement of the chucking part 950.

FIG. 10 is a side cross-sectional view that shows a status in which alignment adjustment of a pair of wafers W is being performed.

FIG. 11 is a side cross-sectional view that shows a status after a pair of wafers W has been bonded.

FIG. 12 is a side cross-sectional view that shows the schematic configuration of a joining apparatus 240.

FIG. 13 is a plan cross-sectional view that shows the schematic configurations of a joining part 202 and a control part 120.

FIG. 14 is a table that schematically shows a table 292 that a history storing part 286 provides.

FIG. 15 is a flow chart for describing the wafer holder WH management method.

FIG. 16 is a plan cross-sectional view that shows the schematic configuration of the joining part 202.

FIG. 17 is a table that schematically shows a table 293 that the history storing part 286 provides.

FIG. 18 is a flow chart for describing the wafer holder WH management method.

### DESCRIPTION OF EXEMPLARY EMBODIMENTS

The present invention will be described below via embodiments of the invention. The embodiments described below do not limit the inventions relating to the Scope of patent Claims. In addition, there is no limitation to the effect that all of the combinations of the special characteristics described in the embodiments are indispensable to the resolution of the invention.

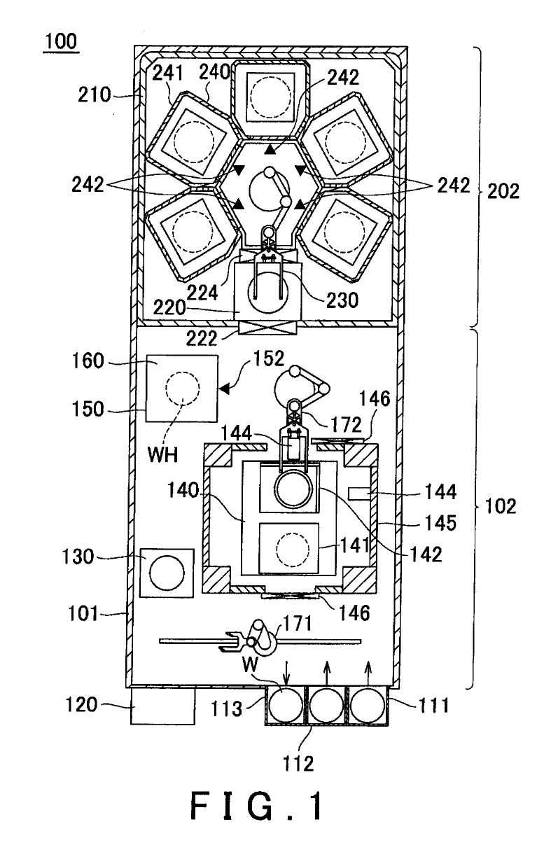

FIG. 1 is a plan view that schematically shows the overall structure of the bonding apparatus 100 as a stacked semiconductor manufacturing apparatus. The bonding apparatus 100 includes an alignment part 102 and a joining part 202 formed at the interior of a common housing 101.

The alignment part 102 has a plurality of wafer cassettes 111, 112, 113 and a control part 120 as a holding member control apparatus facing the exterior of the housing 101. The control part 120 controls operation of the entire bonding apparatus 100.

The wafer cassettes 111, 112, 113 accommodate wafers W that are to be joined at the bonding apparatus 100 or wafers W that have been joined at the bonding apparatus 100. In addition, the wafer cassettes 111, 112, 113 are freely detachably mounted on the housing 101. Through this, it is possible to charge a plurality of wafers W into the bonding apparatus 100 all at once. In addition, it is possible to recover all at once the wafers W that have been joined at the bonding apparatus 100.

The alignment part 102 comprises a prealigner 130, an alignment apparatus 140, a wafer holder rack 150, a wafer extracting part 160 and a pair of robot arms 171, 172 respectively disposed at the interior of the housing 101. The interior of the housing 101 is temperature controlled so that approximately the same temperature as room temperature of the environment in which the bonding apparatus 100 has been installed is maintained. Through this, the accuracy of the alignment apparatus 140 stabilizes, so positioning can be performed with precision.

The prealigner 130 is highly accurate and consequently prealigns the positions of the individual wafers W so that the positions of the wafers W are held within the narrow range of adjustment of the alignment apparatus 140. Through this, positioning by the alignment apparatus 140 can be made reliable.

The wafer holder rack 150 accommodates a plurality of wafer holders WH and causes them to stand by. Holding of the wafers W by the wafer holders WH is performed by electrostatic chucking.

The alignment apparatus 140 includes a fixed stage 141, a moving stage 142 and an interferometer 144. In addition, a heat insulating wall 145 and a shutter 146 are provided to encompass the alignment apparatus 140. The space encompassed by the heat insulating wall 145 and the shutter 146 is connected to an air conditioner, etc. and is temperature controlled, and the alignment accuracy of the alignment apparatus 140 is maintained. The detailed structure and operation of the alignment apparatus 140 will be described later while referring to other drawings.

In the alignment apparatus 140, the movable stage 142 transports wafer holders WH that hold wafers W. In contrast with this, the fixed stage 141 holds the wafer holders WH and the wafers W in a fixed status.

The wafer extracting part 160 extracts wafers W that have been interposed by said wafer holders WH and joined from the wafer holders WH that have been unloaded from joining apparatuses 240 to be discussed later. The wafers W that have been extracted from the wafer holders WH are returned to and accommodated in one among wafer cassettes 111, 112 and 113 by means of robot arms 172 and 171 and the moving stage 142. In addition, the wafer holders WH from which the wafers W have been extracted are returned to the wafer holder rack 150 and are caused to stand by.

A pair of upper and lower barcode readers 152 are disposed as identification information reading parts at the wafer holder WH outlet and inlet ports of the wafer holder rack 150.

Note that the wafers W that have been charged into the bonding apparatus 100 may be, in addition to single silicon wafers, compound semiconductor wafers, glass substrates, etc., terminals, circuits or those on which terminals have been formed. In addition, there are also cases in which the charged wafers W are laminated substrates on which a plurality of wafers W have already been laminated and formed.

From among the pair of robot arms 171, 172, robot arm 171 arranged at the side near the wafer cassettes 111, 112, 113 transports wafers W among the wafer cassettes 111, 112, 113, the prealigner 130 and the alignment apparatus 140. In addition, robot atm 171 also has a function of turning over one of the wafers W to be joined. Through this, it is possible to place surfaces of the wafers W on which a circuit, element or terminal, etc. has been formed in opposition to join them.

On the other hand, robot arm 172 arranged at the side far from the wafer cassettes 111, 112, 113 transports the wafers W and the wafer holders WH among the alignment apparatus 140, the wafer holder rack 150, the wafer extracting part 160 and an airlock 220. In addition, robot arm 172 is also responsible for loading and unloading of the wafer holders WH to and from the wafer holder rack 150.

The joining part 202 has a heat insulating wall 210, an airlock 220, a robot arm 230 and a plurality of joining apparatuses 240. The heat insulating wall 210 encompasses the joining part 202 to maintain a high internal temperature of the joining part 202 while shielding heat radiation to outside the joining part 202. Through this, it is possible to restrict the heat of the joining part 202 from affecting the alignment part 102.

In addition, the joining apparatuses 240 are installed in a space that is encompassed by a heat insulating wall 241 and has been shielded from the outside. The interior of the heat insulating wall 241 is a vacuum chamber.

Robot arm 230 transports wafers W and wafer holders WH between any of the joining apparatuses 240 and the airlock 220. The airlock 220 has jacks 222, 224 that alternately open and close at the alignment part 102 side and the joining part 202 side.

In the case in which the wafers W and the wafer holders WH have been transported to the joining part 202 from the alignment part 102, the first jack 222 of the alignment part 102 side opens, and robot arm 172 loads the wafers W and the wafer holders WH into the airlock 220. Next, jack 222 of the alignment part 101 side is closed, and jack 224 of the joining part 202 side is opened.

Then, robot arm 230 unloads the wafers W and the wafer holders WH from the airlock 220 and inserts them into any of the joining apparatuses 240. The joining apparatuses 240 use heat in applying pressure to the wafers W that have been loaded into the joining apparatuses 240 in a status in which they are interposed by the wafer holders WH. Through this, the wafers W are permanently joined.

In the case in which the wafers W and the wafer holders WH are unloaded from the joining part 202 to the alignment part 102, the aforementioned series of operations are executed in reverse order. Through these series of operations, the wafers W and the wafer holders WH can be loaded to or unloaded from the joining part 202 without the internal atmosphere of the joining part 202 leaking to the alignment part 102 side.

In this way, in many regions within the bonding apparatus 100, the wafers WH are transported by means of robot arms 172 and 230 and moving stage 142 in a status in which the wafers W are held. In the case in which wafer holders WH that hold wafers W are to be transported, robot arms 172 and 230 perform holding by chucking the wafer holders WH by means of vacuum chucking, electrostatic chucking, etc.

In a bonding apparatus 100 that has a structure such as the above, the respective wafers W are individually accommodated in any of the wafer cassettes 111, 112, 113. In addition, the wafer holders WH are also individually accommodated in the wafer holder rack 150.

When the bonding apparatus 100 starts operation, the wafers W are loaded into the prealigner 130 one at a time by means of robot arm 171 and are prealigned. On the other hand, robot arm 172 loads one wafer holder WH onto the moving stage 142 and transports it up to the vicinity of robot arm 171. Robot arm 171 loads wafers W that have been prealigned into this wafer holder WH and causes them to be held.

In the case in which the wafer holder WH that holds the wafers W is the first one, the moving stage 142 again moves to the side of robot arm 172, and the wafer holder WH that has been flipped over by robot arm 172 is installed on the fixed stage 141. On the other hand, in the case in which the wafer holder WH is the second one, the position is monitored by an interferometer 144 while the moving stage 142 is accurately moved to perform joining by performing positioning with respect to the wafers W that have been held on the fixed stage 141 via the wafer holder WH.

The wafer holder WH that has interposed the joined wafers W is transported to the airlock 220 by robot arm 172. The wafers W and the wafer holders WH that have been transported to the airlock 220 are inserted into the joining apparatuses 240.

By means of being heated and pressed at the joining apparatuses 240, the wafers W are mutually joined and become a unit. After that, the wafers W and the wafer holders WH are unloaded from the joining part 202, and the wafers W and the wafer holders WH are separated at the wafer extracting part 160. Following such a usage method, the wafer holders WH are used at two units per set at the bonding apparatus 100.

The bonded wafers W are transported to and accommodated in any of the wafer cassettes 111, 112, 113. In this case, the moving stage 142 also participates in transport from robot arm 172 to robot arm 171. In addition, the wafer holders WH are returned to the wafer holder rack 150 by robot arm 172.

In any case, bar codes are provided on the wafer holders WH, and the barcodes of the pair of upper and lower wafer holders WH are read by means of a pair of upper and lower barcode readers 152. Here, the storage positions of the wafer holders WH in the wafer holder rack 150 are determined for each of the respective wafer holders WH. When robot arm 172 transports the wafer holders WH up to the wafer holder WH outlet and inlet ports of the wafer holder rack 150, the barcodes that have been assigned to the wafer holders WH are read by the barcode readers 152, and the IDs of the wafer holders WH are sent to the control part 120. The control part 120 is equipped with a table in which the IDs of the wafer holders WH and the numbers of the storage positions of the wafer holder rack 150 are associated and reads the numbers of the storage positions associated with the received IDs from said table. Then, the control part 120 controls driving of the wafer holders WH to return the wafer holders WH to the determined storage positions.

In addition, barcode readers 242, which are disposed at the wafer W and wafer holder WH outlet and inlet ports of the joining apparatuses 240, read the barcodes that have been assigned to the wafer holders WH and send the IDs of the wafer holders WH to the control part 120. Here, the IDs of the wafer holders WH that have been output from the barcode readers 242, as discussed above, are used in management of the wafer holders WH.

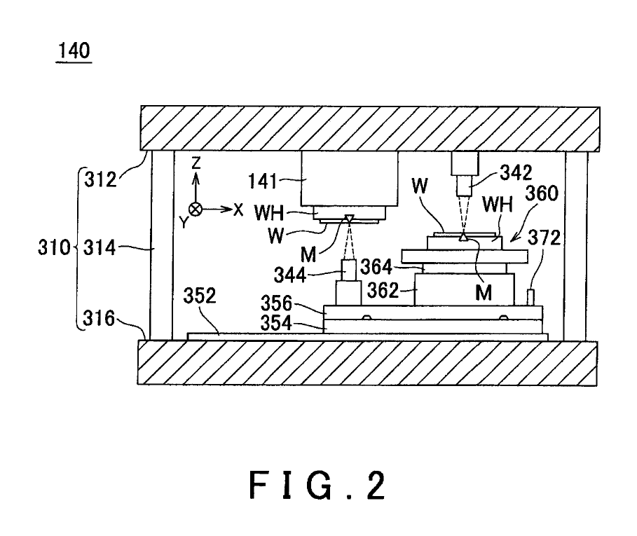

FIG. 2 is a cross-sectional view that schematically shows the structure of the alignment apparatus 140 alone. The alignment apparatus 140 comprises a fixed stage 141, a moving stage 142 and an elevator part 360, which are disposed at the inside of a frame 310.

The frame 310 comprises a mutually parallel and horizontal ceiling plate 312 and bottom plate 316 and a plurality of support columns 314 that connect the ceiling plate 312 and the bottom plate 316. The ceiling plate 312, the support columns 314 and the bottom plate 316 are respectively formed of highly rigid materials and do not deform even in the case in which reaction force relating to operation of internal mechanisms has acted.

The fixed stage 141 is fixed to the lower surface of the ceiling plate 312 and holds the wafers W held by the wafer holders WH at the lower surface. The wafers W are held at the lower surfaces of the wafer holders WH by means of electrostatic chucking and become one of the targets of the alignment to be discussed later.

The moving stage 142 is mounted above the bottom plate 316 and has an X stage 354, which is guided by a guide rail 352 that is fixed to the bottom plate and moves in the X directions, and a Y stage 356, which moves in the Y directions on the X stage 354. Through this, a member that has been loaded onto the moving stage 142 can be moved in any direction on the XY plane.

The elevator part 360 is loaded onto the moving stage 142 and has a cylinder 362 and a piston 364. The piston 364 raises and lowers in the Z directions within the cylinder 362 according to instructions from the respective parts.

The wafer holders WH are held at the upper surface of the piston 364. Also, the wafers W are held on the wafer holders WH. The wafers W become one of the subjects of the alignment to be discussed later.

Note that the wafers W have alignment marks M, which become alignment references, at a surface thereof (the bottom surface in the drawing). However, the alignment marks M are not limited to diagrams, etc. provided for that purpose and may also be wires, bumps, scribe lines, etc. formed on the wafers W.

The alignment apparatus 140 further has a pair of microscopes 342, 344 and a reflecting mirror 372. One of the microscopes 342 is fixed to the lower surface of the ceiling plate 312 leaving a prescribed gap with respect to the fixed stage 141.

The other microscope 344 and the reflecting mirror 372 are loaded to the moving stage 142 along with the elevator part 360. Through this, microscope 344 and the reflecting mirror 372 move on the XY plane along with the elevator part 360. In the case in which the moving stage 142 is in a stationary status, microscope 344, the reflecting mirror 372, and the elevator part 360 have intervals that are already known. In addition, the interval between the center of the elevator part 360 and microscope 344 matches the interval between the center of the fixed stage 141 and microscope 342.

In the case in which the alignment apparatus 140 is in the status in the drawing, microscopes 342 and 344 can be used to observe the alignment marks M of the opposing wafers W, 182. Therefore, for example, it is possible to ascertain accurate positions of the wafers W from images obtained by means of microscope 342. In addition, it is possible to ascertain accurate positions of the wafers W from images obtained by microscope 344.

Reflecting mirror 372 is used in the case in which the amount of movement of the moving stage 142 is measured using a measuring apparatus such as an interferometer. Note that, in FIG. 1, reflecting mirror 372 disposed at a right angle to the surface of the page is shown, but another reflecting mirror 372 that detects movement in the Y directions is also equipped.

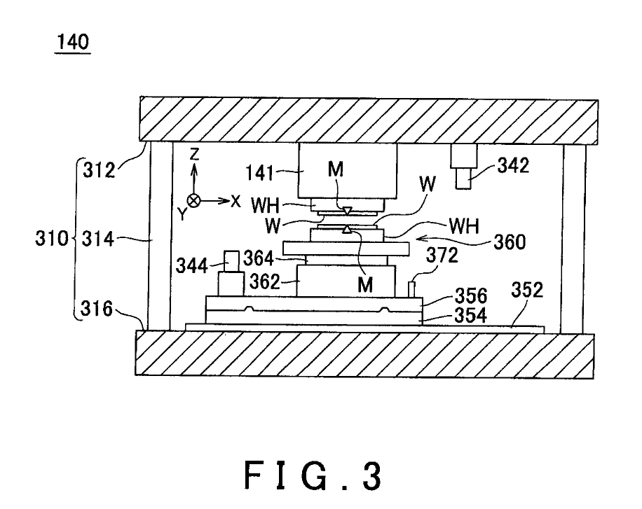

FIG. 3 is a drawing that shows operation of the alignment apparatus 140. As shown in this drawing, the moving stage 142 is moved in the X directions. Here, by making the amount of movement of the moving stage 142 the same as the interval between the center of the elevator part 360 and the center of microscope 344, the wafer W on the moving stage 142 can be transported to directly below the wafer W held by the fixed stage 141. At this time, the alignment marks M of the upper and lower wafers W are positioned on one vertical line.

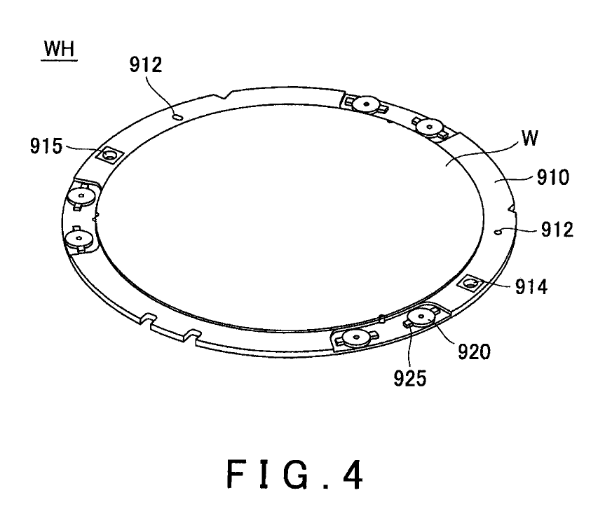

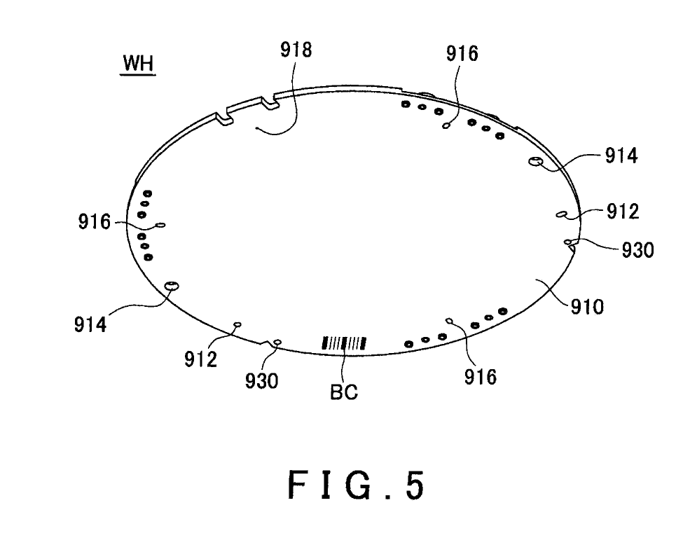

FIG. 4 is a perspective view that shows a condition in which a wafer holder WH held by the movable stage 142 is viewed from above. The wafer W is held at the upper surface of the wafer holder WH. In addition, FIG. 5 is a perspective view that shows a condition in which the same wafer holder WH is viewed from below.

The wafer holder WH has a holder main body 910, chucking elements 920, leaf springs 925 and voltage applying terminals 930 as the electrodes, and, overall, a circular plate whose diameter is one size larger than the wafer W is formed. The holder main body 910 is molded as a unit using highly rigid materials such as sintered ceramics and metals. The chucking elements 920 are formed by magnetic body materials and, at the surface that holds the wafer W, a plurality are disposed further to the outer circumference side than the held wafer W. The leaf springs 925 are formed using titanium (for example, Ti-6Al-4V), and, at the surface that holds the wafer W, a plurality are disposed further to the outer circumference side than the held wafer W. The chucking elements 920 are disposed stacked onto the leaf springs 925. In addition, the voltage applying terminals 930 are provided in an embedded manner at the rear surface of the surface that holds the wafer W.

The region of the surface of the holder main body 910 that holds the wafer W has high flatness and closely adheres to the wafer W. In addition, a plurality of positioning holes 912 and observation holes 914 are formed outside the region of the holder main body 910 where the wafer W closely adheres. In addition, a plurality of working holes 916 are formed at the inside of the region of the holder main body 910 where the wafer W closely adheres.

The positioning holes 912 engage with positioning pins provided on, for example, robot arms 171, 172 and 230 and contribute to positioning of the wafer holder WH. Fiducial marks 915 are provided at the end faces of the sides of the observation holes 914 that hold the wafer W. By observing the fiducial marks 915 via the observation holes 914, it is possible to surmise the position of the wafer W, which has become invisible in the case in which it is interposed by a pair of wafer holders WH. Pushpins are inserted into the working holes 916 from the lower surface of the holder main body 910. Through this, it is possible to extract wafers W from the wafer holders WH.

The chucking elements 920 and the leaf springs 925 are arrayed in a recessed region formed on the holder main body 910 so that the upper surfaces are positioned within approximately the same plane as the plane that holds the wafer W. The voltage applying terminals 930 are embedded in the holder main body 910 at the rear surface with respect to the surface that holds the wafer W. By applying voltage via the voltage applying terminals 930, a potential difference is generated between the wafer holder WH and the wafer W to chuck the wafer W to the wafer holder WH.

A barcode BC is affixed to the rear surface of the wafer holder WH as an identification display. This barcode BC is an identifier that indicates the ID as identification information assigned to the respective wafer holders WH.

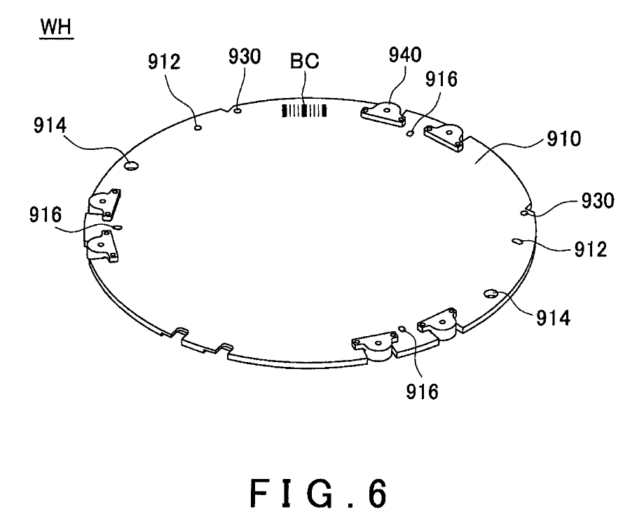

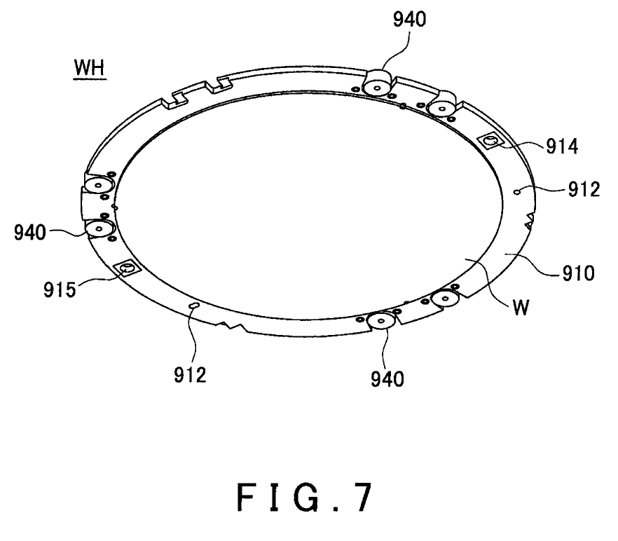

FIG. 6 is a perspective view that shows a condition in which a wafer holder WH held by the fixed stage 141 is viewed from above. Also, FIG. 7 is a perspective view that shows a condition in which the same wafer holder WH is viewed from below. This wafer holder WH holds the wafer W at the lower surface thereof.

The wafer holder WH has a holder main body 910, voltage applying terminals 930 and permanent magnets 940, and, overall, a circular plate whose diameter is one size larger than the wafer W is formed. The holder main body 910 is molded as a unit using highly rigid materials such as sintered ceramics and metals. The permanent magnets 940 are Al—Ni—Co magnets and are plurally disposed further to the outside than the wafer W at the surface that holds the wafer W. Voltage applying terminals 930 are provided in an embedded manner at the rear surface of the surface that holds the wafer W.

The region of the surface of the holder main body 910 that holds the wafer W has high flatness and closely adheres to the wafer W. In addition, a plurality of positioning holes 912 and observation holes 914 are formed outside the region of the holder main body 910 where the wafer W closely adheres. In addition, a plurality of working holes 916 are formed at the inside of the region of the holder main body 910 where the wafer W closely adheres.

The positioning holes 912 engage with positioning pins provided on, for example, the alignment apparatus 140 and contribute to positioning of the wafer holder WH. Fiducial marks 915 are provided at the end faces of the sides of the observation holes 914 that hold the wafer W. By observing the fiducial marks 915 via the observation holes 914, it is possible to surmise the position of the wafer W, which has become invisible in the case in which it is interposed by the wafer holders WH, 194. Pushpins are inserted into the working holes 916 from the rear surface of the wafer holder WH. Through this, it is possible to extract wafers W from the wafer holders WH.

The permanent magnets 940 are disposed at the outer edge part of the holder main body 910 so that the lower surfaces are positioned within a plane shared with the lower surface of the wafer W. The voltage applying terminals 930 are embedded in the holder main body 910 at the rear surface opposite the surface that holds the wafer W. By applying voltage via the voltage applying terminals 930, a potential difference is generated between the wafer holder WH and the wafer W, and the wafer W is chucked to the wafer holder WH.

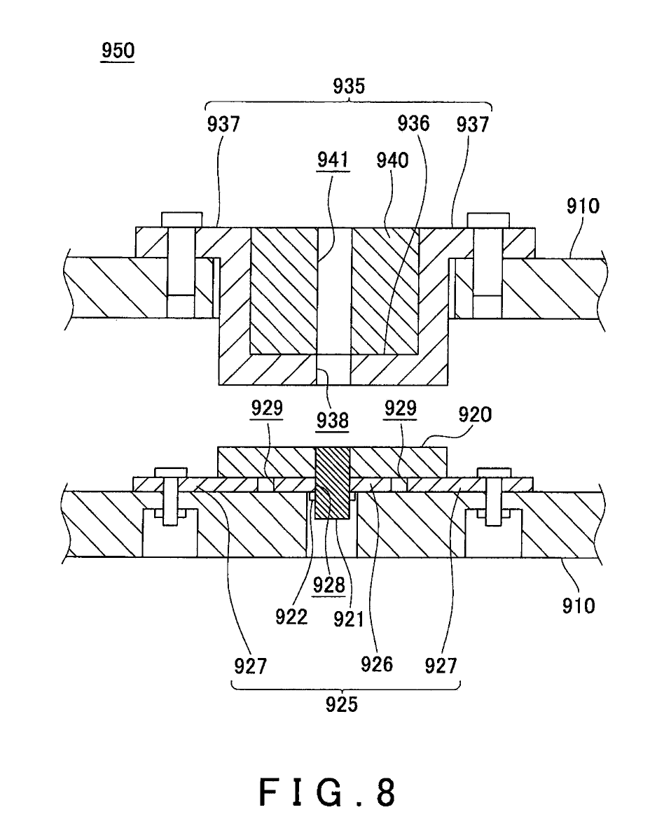

FIG. 8 is a side cross-sectional view that shows an enlargement of a chucking part 950 that chucks a pair of wafer holders WH. As shown in this drawing, the chucking elements 920 are formed in a circular plate shape, and the leaf springs 925 are comprised of a circular plate-shaped portion 926 of the same diameter as the chucking element 920 and a pair of rectangular portions 927 that extend out to the two sides along the radius direction from the circular plate-shaped portion 926. The rectangular portions 927 are fastened to the holder main body 910.

In addition, a circular hole 928 is formed at the center part of the circular plate-shaped portion 926, and a fixing pin 921 that is inserted through a circular hole 928 is fixed to the center part of the chucking element 920. A screw groove is formed in the fixing pin 921, a nut 922 is engaged by screwing, and by fastening the circular plate-shaped portion 926 using the chucking element 920 and the nut 922, the chucking element 920 is fixed to the circular plate-shaped portion 926. In addition, a pair of slits 929 are formed symmetrically with respect to the center in the circular plate-shaped portion 926, and the center part of the circular plate-shaped portion 926 is easily elastically deformable in the thickness directions.

In addition, the permanent magnet 940 is attached to the wafer holder WH via a cover member 935 formed by a magnetic body material. The permanent magnet 940 is formed in a circular column shape, and a circular hole 941 is formed in the shaft of the permanent magnet 940. In addition, the cover member 935 comprises a bottom-affixed cylindrical portion 936 that accommodates the permanent magnet 940 and a pair of rectangular portions 937 that extend out to both sides along the radial directions from the opening end part of the cylindrical portion 936. The rectangular portion 937 is fastened to the holder main body 910. In addition, a cylindrical hole 938 is formed at the center part of the bottom part of the cylindrical portion 936.

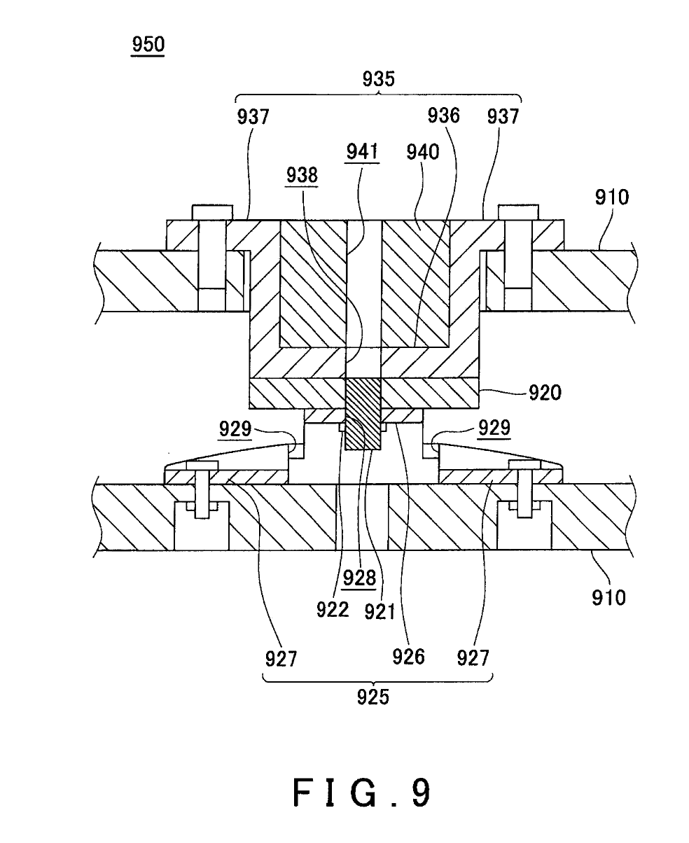

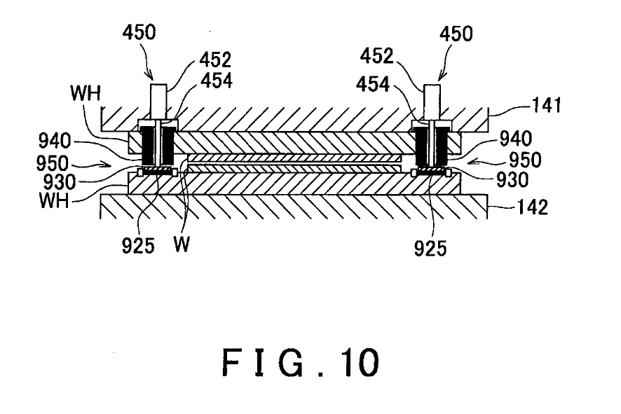

FIG. 9 is a side cross-sectional view that shows an enlargement of a chucking part 950, in which a pair wafer holders WH have been chucked. As shown in this drawing, the chucking element 920 is attracted toward the permanent magnet 940 by means of the magnetic attraction force generated with respect to the permanent magnet 940. At this time, the center part of the circular plate-shaped portion 926 of the leaf spring 925 is elastically deformed to the side of the permanent magnet 940, and the chucking element 920 is chucked to the permanent magnet 940 interposing the cover member 935. Through this, a pair of wafer holders WH are fixed in a status in which a pair of wafers W are held in an interposed manner.

FIG. 10 is a side cross-sectional view that shows a status immediately prior to bonding a pair of wafers W together, that is, in which alignment adjustment of a pair of wafers W is being performed. As shown in this drawing, a plurality of pushpins 450, as chucking regulating portions that regulate chucking of the chucking elements 920 and the permanent magnets 940 of the chucking parts 950, are supported by the fixed stage 141. The respective pushpins 450 are disposed in vertical opposition with the respective chucking parts 950.

The pushpins 450 comprise a cylinder part 452 fixed to the fixed stage 141 and a pin 454 that is freely slidably supported by the cylinder part 452. The axial directions of the cylinder part 452 and the pins 454 are disposed in the thickness directions of the wafer holders WH, and the pins 454 are inserted through the circular holes 941 of the permanent magnets 940 and the circular holes 938 of the cover members 935.

The pushpins 450 are air pressure driven actuators, and by increasing and decreasing the internal pressure of the cylinder parts 452, the pins 454 advance and withdraw to and from the chucking elements 920. Here, in a status in which the internal pressure of the cylinder parts 452 has been raised, these force amounts are set so that the combined force of the load applied from the pins 454 to the chucking elements 920 and the elastic force of the leaf springs 925 becomes larger than the magnetic attraction force between the chucking elements 920 and the permanent magnets 940. Through this, in a status in which the internal pressure of the cylinder parts 452 has increased, the chucking elements 920 resist the magnetic attraction force between the chucking elements 920 and the permanent magnets 940 by means of the pins 454, are pressed down in the direction of separation from the permanent magnets 940, and, having done this, the chucking of the chucking elements 920 and the permanent magnets 940 is released.

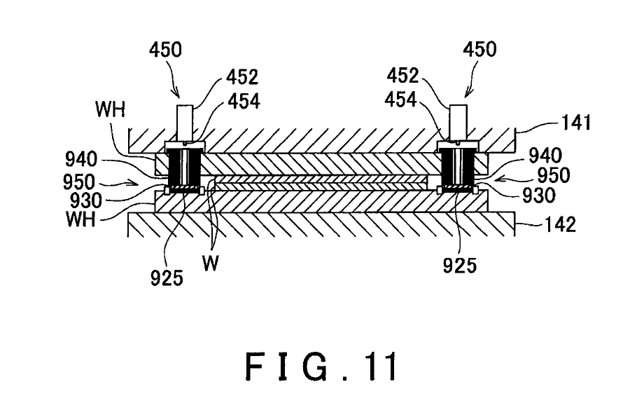

FIG. 11 is a side cross-sectional view that shows the status after a pair of wafers W has been bonded together. As shown in this drawing, these force amounts are set so that the magnetic attraction force between the chucking elements 920 and the permanent magnets 940 becomes larger than the elastic force of the leaf springs 925. Through this, in a status in which energizing of the chucking elements 920 by the pins 454 has been canceled, the chucking elements 920, by means of the magnetic attraction force with respect to the permanent magnets 940, are attracted to the side of the permanent magnets 940 while elastically deforming the leaf springs 925 and are chucked to the permanent magnets 940.

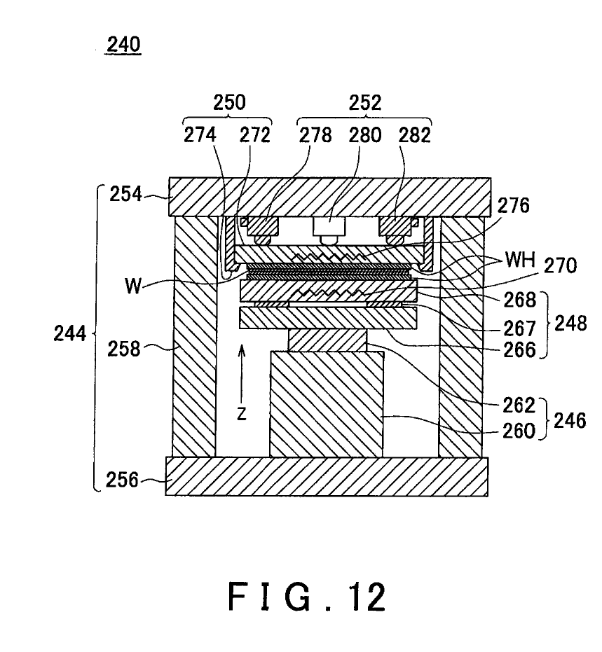

FIG. 12 is a side cross-sectional view that shows the overall configuration of a joining apparatus 240. As shown in this drawing, the joining apparatus 240 comprises a pressing part 246, a pressure applying stage 248, a pressure receiving stage 250 and a pressure detecting part 252 arranged at the interior of a frame 244.

The frame 244 comprises a mutually parallel and horizontal ceiling plate 254 and bottom plate 256 and a plurality of support columns 258 that connect the ceiling plate 254 and the bottom plate 256. The ceiling plate 254, the support columns 258 and the bottom plate 256 have rigidity to the extent that deformation does not occur in the case in which reaction force from pressure application to the wafers W and the wafer holders WH has acted.

At the inside of the frame 244, a pressing part 246 is arranged on the bottom plate 256. The pressing part 246 has a cylinder 260 fixed to the upper surface of the bottom plate 256 and a piston 262 arranged at the inside of the cylinder 260. The piston 262 is driven by means of a fluid circuit, a cam, a gear train, etc. that are not shown and raise and lower in a direction orthogonal to the bottom plate 256, which is shown by arrow Z in the drawing.

The pressure applying stage 248 is mounted at the upper end of the piston 262. The pressure applying stage 248 has a horizontal plate-shaped support part 266 that is connected to the upper end of the piston 262 and a plate-shaped first substrate holding part 268 parallel to the support part 266.

The first substrate holding part 268 is supported from the support part 266 via a plurality of actuators 267. In addition to the pair of actuators 267 shown, actuators 267 are also arranged forward and backward with respect to the surface of the page. In addition, these respective actuators 267 can be mutually independently operated. By means of such a structure, by appropriately operating the actuators 267, it is possible to vary the inclination of the first substrate holding part 268 as desired. Also, the first substrate holding part 268 has a heater 270 and is heated by means of said heater 270.

In addition, the wafers W are electrostatically chucked to the wafer holders WH, and the first substrate holding part 268 chucks the wafer holders WH to the upper surface by means of, for example, vacuum chucking. Through this, the wafers W sway along with the wafer holders WH and the first substrate holding part 268 and also are prevented from moving or falling out from the first substrate holding part 268.

The pressure receiving stage 250 has a second substrate holding part 272 and a plurality of suspension parts 274. The suspension parts 274 are vertically suspended from the lower surface of the ceiling plate 254. The second substrate holding part 272 is supported from below at the vicinity of the lower ends of the suspension parts 274 and is arranged in opposition with the pressure applying stage 248. The second substrate holding part 272 chucks the wafer holders WH to the lower surface by means of, for example, vacuum chucking. In addition, the second substrate holding part 272 has a heater 276 and is heated by said heater 276.

The second substrate holding part 272 is supported from below by means of the suspension parts 274 and is not restricted from moving upward. However, a plurality of load cells 278, 280, 282 are interposed between the ceiling plate 254 and the second substrate holding part 272. The plurality of load cells 278, 280, 282 form a part of the pressure detecting part 252 and restrict upward movement of the second substrate holding part 272 while detecting pressure applied upward with respect to the second substrate holding part 272.

In the case in which the support column 258 of the pressing part 246 is pulled into the cylinder 260, and the pressure applying stage 248 descends, a wide gap is formed between the pressure applying stage 248 and the pressure receiving stage 250. A pair of wafers W subject to joining are inserted from the side with respect to the aforementioned gap along with a pair of wafer holders WH that interpose these and are loaded onto the pressure applying stage 248.

Here, the pressure applying stage 248 ascends toward the pressure receiving stage 250 and presses the pair of wafers W. Also, during pressing, heaters 270 and 276 heat the pressure applying stage 248 and the pressure receiving stage 250. Through this, the pair of wafers W are joined. Here, the set temperatures of heaters 270 and 276 are 450° C.

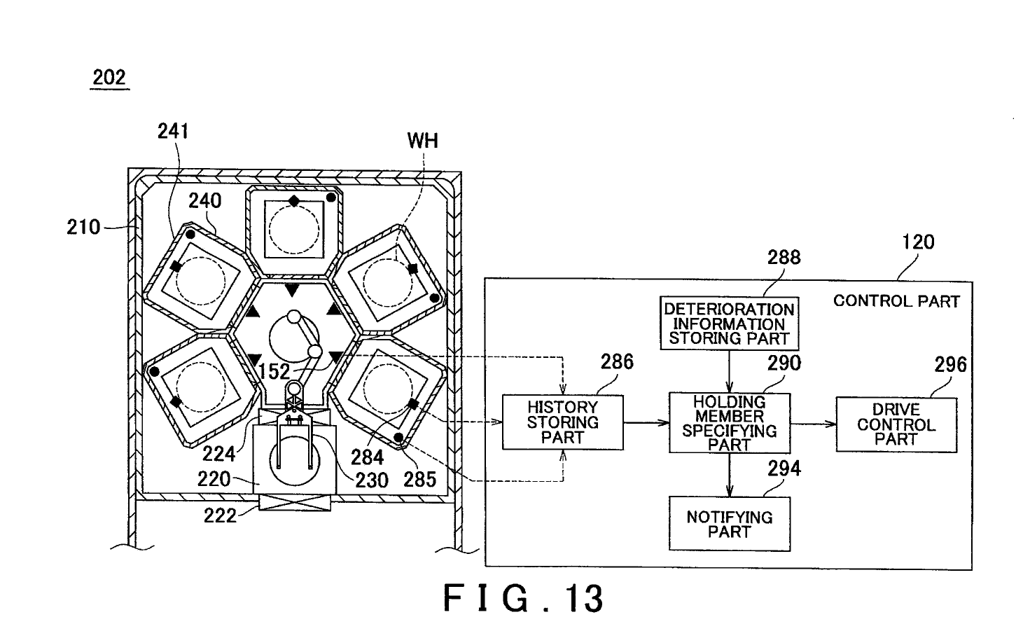

FIG. 13 is a plan cross-sectional view that shows the overall configuration of the joining part 202 and the control part 120. As shown in this drawing, comprised by the respective joining apparatuses 240 are a temperature sensor 284, as a temperature measuring part that measures the temperatures of heaters 270 and 276, and an air pressure sensor 285 that measures the air pressure of the vacuum chamber in which the joining apparatuses 240 are disposed. In addition, the control part 120 discussed above comprises a history storing part 286 that associates and stores the measurement results sent from the temperature sensor 284 and pressure sensor 285 and the IDs of the wafer holders WH sent from the barcode readers 242.

In addition, the control part 120 comprises a deterioration information storing part 288, a holding member specifying part 290, a notifying part 294 and a drive control part 296 of the robot arm 172. The deterioration information storing part 288 stores the first threshold value and the second threshold value of the temperatures (specifically, the heating temperatures of the wafer holders WH) of the heaters 270, 276, the threshold value of the numbers of times used (specifically, the numbers of times the wafer holders WH have been subject to pressure application and heating) of the wafer holders WH, and the threshold value of the ambient pressures of the joining apparatuses 240. Here, in the present embodiment, the first threshold value of the heating temperatures of the wafer holders WH is 500° C., the second threshold value is 600° C., the threshold value of the numbers of times used of the wafer holders WH is 1000 times, and the threshold value of the ambient pressures of the joining apparatuses 240 is 100 Pa.

The aforementioned first threshold value is set to a temperature at which the permanent magnets 940 are thermally demagnetized and cannot recover their original magnetic force. In addition, the second threshold value is such that the leaf springs 925 are set to a temperature at which embrittlement occurs due to reasons such as heating being performed to release residual warping. In addition, the threshold value of the number of times used is set to a number of times at which cleaning of the wafer holders WH will be required. Also, the ambient pressure threshold value is set to a pressure at which oxidation can be produced in the voltage applying terminals 930. Here, the voltage applying terminals 930 can oxidize when exposed to the atmosphere in a status in which heating to a high temperature has been performed.

In addition, the holding member specifying part 290 refers to the usage history of the wafer holders WH that is stored in the history storing part 286 and the threshold values stored in the deterioration information storing part 288 to specify the wafer holders WH whose use is to be suspended. In addition, the notifying part 294, for example, displays the wafer holders WH whose use is to be suspended and various information with respect to said wafer holders WH on a monitor to give notification to the user. In addition, the drive control circuit 296 controls robot alai 172 so that wafer holders WH with IDs specified by the holding member specifying part 290 remain in the wafer holder rack 150 without being used, and wafer holders WH with IDs other than said IDs are used.

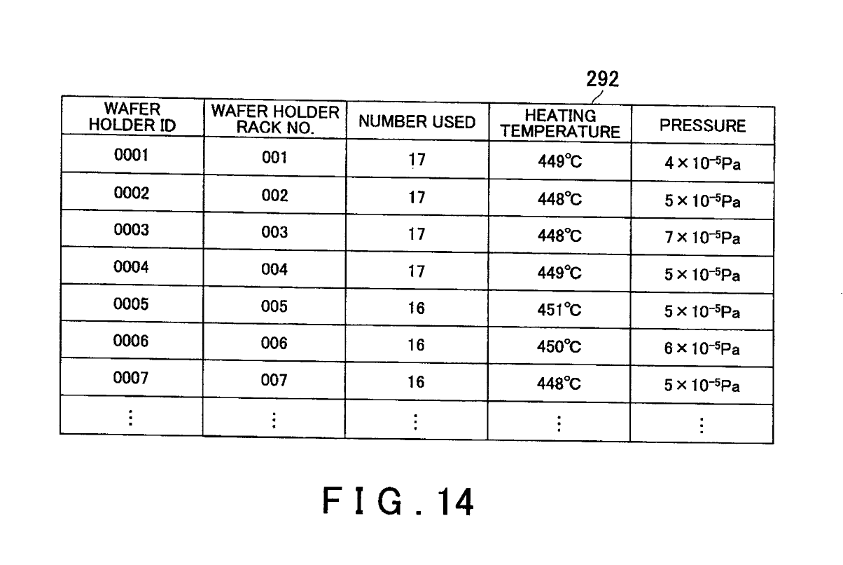

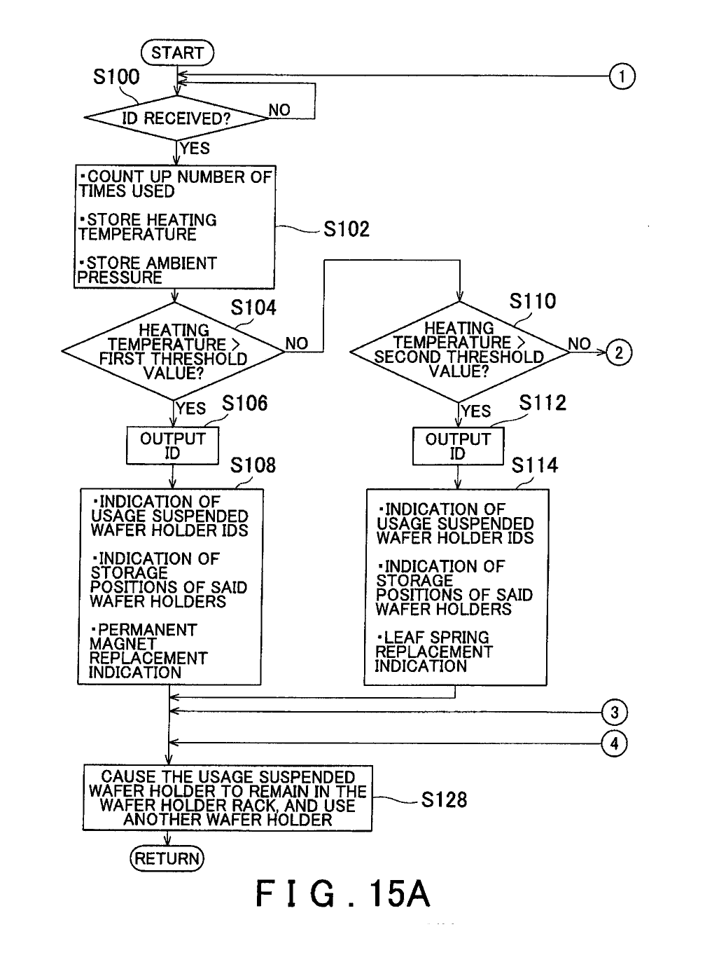

FIG. 14 is a table that shows an overview of the table 292 with which the history storing part 286 is equipped. As shown in this table, the IDs of the wafer holders WH, the numbers of the storage positions at which the wafer holders WH are stored in the wafer holder rack 150, the numbers of times used of the wafer holders WH, the heating temperatures of the wafer holders WH, and the ambient pressures of the joining apparatuses 240 when the wafer holders WH have been subjected to pressure application and heating are stored on the same line in said table 292.

The IDs of the wafer holders WH and the numbers of the storage positions at which the wafer holders WH are stored in the wafer holder rack 150 are stored in the table 292 in advance prior to the start of usage of the wafer holders WH, and the numbers of times used of the wafer holders WH, the heating temperatures of the wafer holders WH, and the ambient pressures of the joining apparatuses 240 when the wafer holders WH have been subject to pressure application and heating are updated during usage of the wafer holders WH.

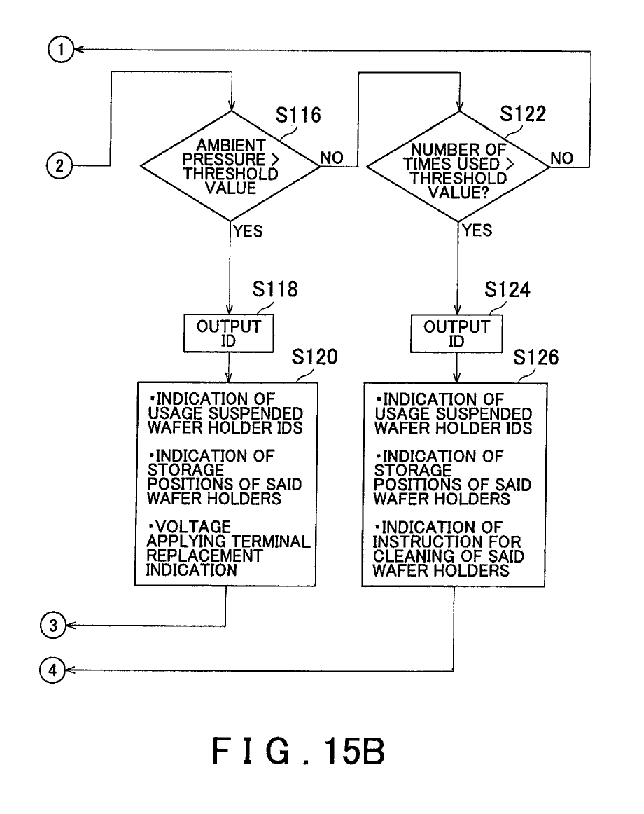

FIG. 15 is a flow chart for describing the management method of the wafer holders WH. This flow is started when the power of the bonding apparatus 100 is turned on, and there is a shift to step S100. In step S100, the control part 120 determines whether or not ID data of the wafer holders WH has been received from the barcode readers 242, and if the determination is affirmative, there is a shift to step S102.

In step S102, the history storing part 286 counts up the numbers of times used of the wafer holders WH stored in table 292 to correspond to the received IDs of the wafer holders WH. In addition, the history storing part 286 stores in table 292 the temperatures sent from the temperature sensors 284 of the joining apparatus 280 corresponding to the barcode readers 242 that have sent the IDs as well as the air pressures sent from the air pressure sensors 285 of said joining apparatuses 240. At this time, by storing the IDs, the numbers of times used, the temperatures, and the air pressures of the wafer holders WH on the same line of the table 292, these data are associated.

Next, in step S104, the holding member specifying part 290 makes a determination as to whether or not the temperatures stored on the same lines of table 292 as said IDs have exceeded the first threshold value stored in the deterioration information storing part 288, and if the determination is affirmative, there is a shift to step S106, and if the determination is negative, there is a shift to step S110.

In step S106, the holding member specifying part 290 outputs said IDs to the notifying part 294 and the drive control part 296, and there is a shift to step S108. In step S108, the notifying part 294 displays on the monitor an indication to the effect that usage of wafer holders WH with said IDs is to be suspended, the storage positions of said wafer holders WH in the wafer holder rack 150, and an indication that instructs replacement of the permanent magnets 940. Then, there is a shift to step S128.

On the other hand, in step S110, the holding member specifying part 290 makes a determination as to whether or not the temperatures stored on the same lines of table 292 as said IDs have exceeded the second threshold value stored in the deterioration information storing part 288, and if the determination is affirmative, there is a shift to step S112, and if the determination is negative, there is a shift to step S116.

In step S112, the holding member specifying part 290 outputs said IDs to the notifying part 294 and the drive control part 296, and there is a shift to step S114. In step S114, the notifying part 294 displays on the monitor an indication to the effect that usage of wafer holders WH with said IDs is to be suspended, the storage positions of said wafer holders WH in the wafer holder rack 150, and a display that instructs replacement of the leaf springs 925. Then, there is a shift to step S128.

On the other hand, in step S116, the holding member specifying part 290 makes a determination as to whether or not the air pressures stored on the same lines of table 292 as said IDs have exceeded the threshold values stored in the deterioration information storing part 288, and if the determination is affirmative, there is a shift to step S118, and if the determination is negative, there is a shift to step S122.

In step S118, the holding member specifying part 290 outputs said IDs to the notifying part 294 and the drive control part 296, and there is a shift to step S120. In step S120, the notifying part 294 displays on the monitor an indication to the effect that usage of the wafer holders WH with said IDs is to be suspended, the storage positions of said wafer holders WH in the wafer holder rack 150, and an indication that instructs replacement of the voltage applying terminals 930. Then, there is a shift to step S128.

On the other hand, in step S122, the holding member specifying part 290 makes a determination as to whether or not the numbers of times used stored on the same lines of table 292 as said IDs have exceeded the threshold values stored in the deterioration information storing part 288, and if the determination is affirmative, there is a shift to step S124, and if the determination is negative, there is a shift to step S100.

In step S124, the holding member specifying part 290 outputs said IDs to the notifying part 294 and the drive control part 296, and there is a shift to step S126. In step S126, the notifying part 294 displays on the monitor an indication to the effect that usage of wafer holders WH with said IDs is to be suspended, the storage positions of said wafer holders WH in the wafer holder rack 150, and an indication to the effect that cleaning of wafer holders WH with said IDs is instructed. Then, there is a shift to step S128.

In step S128, the drive control part 296 controls robot arm 172 so that wafer holders WH with said IDs are not extracted from the wafer holder rack 150 and wafer holders WH with other IDs are extracted from the wafer holder rack 150 and transported to the joining apparatuses 240. With that, this flow ends.

Specifically, in the present embodiment, in the case in which the heating temperature of any of the wafer holders WH has exceeded 500° C., the holding member specifying part 290 specifies and outputs the IDs of said wafer holders WH. Then, the drive control part 296 controls robot arm 172 so that wafer holders WH with said IDs are not extracted from the wafer holder rack 150 and wafer holders WH with other IDs are extracted from the wafer holder rack 150 and are transported to the joining apparatuses 240. In addition, the notifying part 294 displays on the monitor the IDs of the wafer holders WH whose usage is to be suspended, the storage positions of said wafer holders WH in the wafer holder rack 150, and an indication that instructs replacement of the permanent magnets 240.

Here, the permanent magnets 940 are Al—Ni—Co magnets, and in the case in which heating to a temperature that exceeds approximately 500° C. has been performed, thermal demagnetization is performed, and the original magnetic force cannot subsequently be recovered. In this case, the chucking force of the pair of wafer holders WH cannot be adequately ensured, and there is a possibility that the pair of wafer holders WH will shift and come off during transport of the wafer holders WH that interpose the wafers W to the joining apparatuses 240. Due to this, there is a possibility that positional misalignment will occur in the pair of wafers W that has been subject to alignment adjustment and that joining defects of the pair of wafers WH will occur. In addition, there is a possibility that it will be necessary to stop driving of the bonding apparatus 100 to eject the wafers W and the wafer holders WH.

However, in the present embodiment, in the case in which the permanent magnets 940 have thermally demagnetized and subsequently have not been able to recover the original magnetic force, usage of the wafer holders WH that comprise said permanent magnets 940 is suspended, so it is possible to restrict positional misalignment of the pair of wafers W after alignment adjustment, and it is possible to restrict generation of bonding defects of the pair of wafers W. In addition, it is possible to restrict interruption of operations of the bonding apparatus 100 from occurring. Also, it is possible for the user to ascertain from the monitor display the fact that replacement of the permanent magnets 940 is required, as well as the IDs of the wafer holders WH whose usage has been suspended and the storage positions of said wafer holders WH in the wafer holder rack 150.

In addition, in the present embodiment, in the case in which the heating temperatures of any of the wafer holders WH have exceeded 600° C., the holding member specifying part 290 specifies and outputs the IDs of said wafer holders WH. Then, the drive control part 296 controls robot arm 172 so that wafer holders WH with said IDs are not extracted from the wafer holder rack 150, and wafer holders WH with other IDs are extracted from the wafer holder rack 150 and transported to the joining apparatuses 240. In addition, the notifying part 294 displays on the monitor the IDs of the wafer holders WH whose usage is to be suspended, the storage positions of said wafer holders WH in the wafer holder rack 150, and an indication that instructs replacement of the leaf springs 925.

Here, the leaf springs 925 are titanium, and in the case in which heating up to a temperature that exceeds approximately 600° C. has been performed, residual warping is released, and embrittlement occurs. In this case, it is possible for the accuracy of alignment adjustment of the wafers W to decrease without regulation of the chucking of the chucking part 950 being performed well.

However, in the present embodiment, usage of wafer holders WH that comprise the embrittled leaf springs 925 is suspended, so it is possible to restrict the decrease in the accuracy of the alignment adjustment. In addition, the user is able to ascertain from the monitor display the fact that replacement of the leaf springs 925 is required, the IDs of the wafer holders WH whose usage has been suspended, and the storage positions of said wafer holders WH in the wafer holder rack 150.

In addition, in the present embodiment, in the case in which the ambient pressures when any of the wafer holders WH have been heated have exceeded 100 Pa, the holding member specifying part 290 specifies and outputs the IDs of said wafer holders WH. Then, the drive control part 296 controls robot arm 172 so that wafer holders W11 with said IDs are not extracted from the wafer holder rack 150 and wafer holders WH with other IDs are extracted from the wafer holder rack 150 and transported to the joining apparatuses 240. In addition, the notifying part 294 displays on the monitor the IDs of the wafer holders WH whose usage is to be suspended, the storage positions of said wafer holders WH in the wafer holder rack 150, and an indication that instructs replacement of the voltage applying terminals 930.

Here, the voltage applying terminals 930 are such that when exposing to the atmosphere has been performed in a status in which heating to a high temperature has been performed, oxidation occurs, causing conductivity to decrease. In this case, there is a possibility that it will not be possible to adequately increase the charging amount of the wafer holders WH, and it will not be possible for the wafer holders WH to adequately ensure an electrostatic chucking function.

However, in the present embodiment, usage of wafer holders WH that comprise the oxidized voltage applying terminals 930 will be suspended, so it is possible to restrict wafers W from falling from the wafer holders WH and generation of positional misalignment of the wafers W with respect to the wafer holders WH. In addition, the user is able to ascertain from the monitor display the fact that replacement of the voltage applying terminals 930 is required, the IDs of the wafer holders WH whose usage has been suspended, and the storage positions of said wafer holders WH in the wafer holder rack 150.

In addition, in the present embodiment, in the case in which the number of usages of any of the wafer holders WH has exceeded 1000 times, the holding member specifying part 290 specifies and outputs the IDs of said wafer holders WH. Then, the drive control part 296 controls the robot arm 172 so that wafer holders WH with said IDs are not extracted from the wafer holder rack 150, and wafer holders WH with other IDs are extracted from the wafer holder rack 150 and transported to the joining apparatuses 240. In addition, the notifying part 294 displays on the monitor the IDs of the wafer holders WH whose usage is to be suspended, the storage positions of said wafer holders WH in the wafer holder rack 150, and an indication that instructs cleaning of said wafer holders WH.

Here, by means of the wafer holders WH being repeatedly used, there is a possibility that dust and dirt will remain in the wafer holders WH. In the present document, usage of wafer holders WH whose numbers of times used have exceeded the tolerance value is suspended. In addition, the user is able to ascertain from the monitor display the IDs of the wafer holders WH whose usage has been suspended, the storage positions of said wafer holders WH in the wafer holder rack 150, and the fact that cleaning of said wafer holders WH is required.

Note that, in the present embodiment, usage of the wafer holders WH specified by the holding member specifying part 290 has been immediately suspended but is not essential. For example, usage of said wafer holders WH may continue, and a warning (specifically, a message that urges replacement) may be output.

Next, other examples of management methods of other wafer holders WH will be described. Note that identical symbols will be assigned to configurations that are similar to those of the aforementioned embodiments, and descriptions will be omitted.

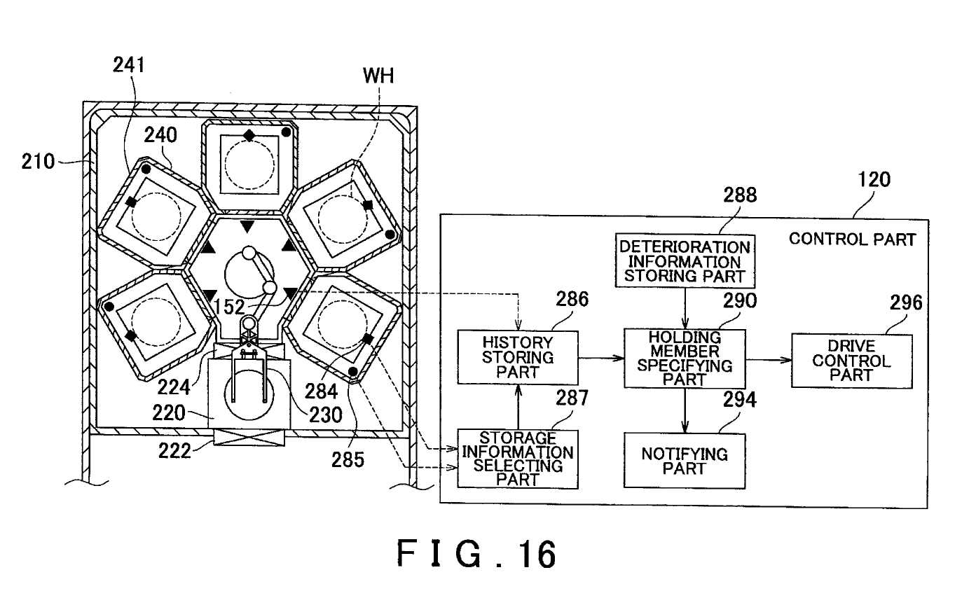

FIG. 16 is a plan cross-sectional view that shows the overall configuration of the bonding part 202. As shown in this figure, the control part 120 comprises a storage information selecting part 287 that receives measurement results from the temperature sensors 284 and the air pressure sensors 285. Stored in this storage information selecting part 287 are the aforementioned first threshold value and the aforementioned second threshold value of the wafer holders WH and the ambient pressure threshold value of the joining apparatuses 240, and the storage information selecting part 287 compares the received temperatures and pressures with these threshold values. Then, the storage information selecting part 287, in the case in which the received temperatures and pressures are higher than threshold values, sends the received temperature information and pressure information to the history storing part 286.

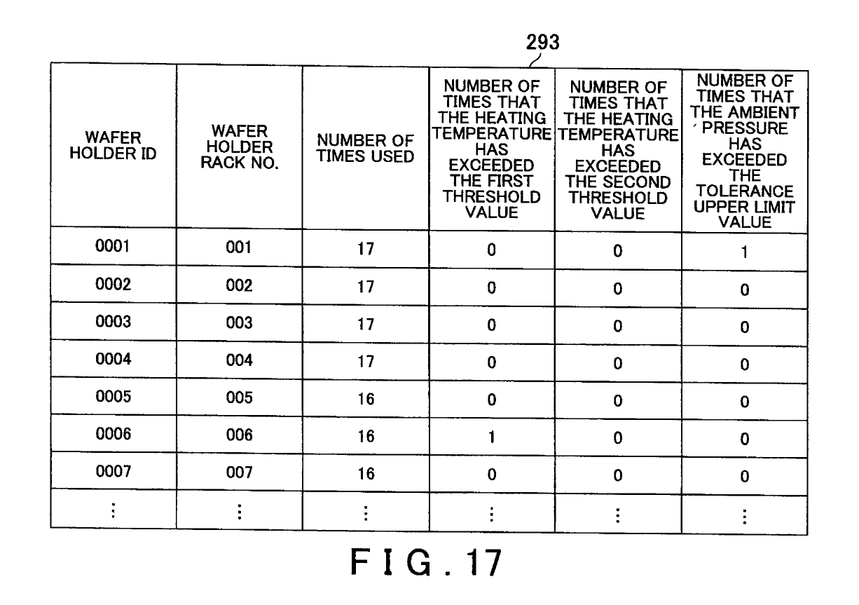

FIG. 17 is a table that schematically shows table 293 that the history storing part 286 comprises. As shown in this table, the IDs of the wafer holders WH, the numbers of the storage positions of the wafer holder rack 150 in which the wafer holders WH are stored, the numbers of times used of the wafer holders WH, the numbers of times the heating temperatures of the wafer holders WH have exceeded the first threshold value as a tolerance value, the numbers of times the heating temperatures of the wafer holders WH have exceeded the second threshold values as a tolerance value, and the numbers of times the ambient pressures of the joining apparatuses 240 when the wafer holders WH have been subject to pressure application and heating have exceeded the tolerance upper limit value are stored on the same lines in said table 293.

The IDs of the wafer holders WH and the numbers of the storage positions of the wafer holder 150 where the wafer holders WH are stored are stored in the table 293 in advance prior to the wafer holders WH being used, and the numbers of times used of the wafer holders WH, the numbers of times that the heating temperatures of the wafer holders WH have exceeded the first threshold value, the numbers of times that the heating temperatures of the wafer holders WH have exceeded the second threshold value, and the numbers of times the ambient pressures of joining apparatuses 240 when the wafer holders WH have been subject to pressure application and heating have exceeded the tolerance value upper limit value are updated during usage of the wafer holders WH.

Here, stored in the deterioration information storing part 288 are the threshold value of the numbers of times used of the wafer holders WH, the threshold value of the numbers of times that the heating temperatures of the wafer holders WH have exceeded the first threshold value, the threshold value of the numbers of times that the heating temperatures of the wafer holders WH have exceeded the second threshold value, and the threshold value of the numbers of times the ambient pressures of the joining apparatuses 240 when the wafer holders WH had been subject to pressure application and heating had exceeded the tolerance value upper limit value.

Note that the first threshold value and the threshold value of the numbers of times the first threshold value has been exceeded are determined according to the endurance test results with respect to the second threshold value, the threshold value of the number of times the second threshold value has been exceeded, the threshold value of the number of times used of the wafer holders WH, the threshold value of the ambient pressures of the joining apparatuses 240, and the threshold value of the number of times said threshold value has been exceeded.

The threshold value of the number of times the aforementioned first threshold value has been exceeded is set to the number of times a status in which the permanent magnets 940 have thermally demagnetized and are unable to recover the original magnetic force has been reached. In addition, the aforementioned second threshold value is set to the number of times a status in which the leaf springs 925 have become embrittled for reasons such as heating having been performed to release the residual distortion has been reached. In addition, the threshold value of the number of times used is set to the number of times a status in which the flatness of the wafer holders WH has deteriorated to beyond the tolerance range has been reached. In addition, the threshold value of the ambient pressure is set to the number of times a status in which oxidation has occurred in the voltage applying terminals 930 has been reached. Here, the wafer holders WH are subject to pressure application at a high pressure in a status in which heating to a high temperature has been performed, so in the case in which the number of times used has become extremely large, burrs may be produced. In addition, the voltage applying elements 930 may oxidize when exposed to the atmosphere in a status in which heating to a high temperature has been performed, and when the number of times thereof increases, it becomes no longer possible to adequately ensure conductivity.

In addition, the holding member specifying part 290, in the case in which the numbers of times used of the wafer holders WH, the numbers of times the heating temperatures of the wafer holders WH have exceeded the first threshold value, the numbers of times the heating temperatures of the wafer holders WH has exceeded the second threshold value, and the numbers of times the ambient pressure of the joining apparatuses 240 when the wafer holders WH have been subject to pressure application and heating have exceeded the tolerance value upper limit value, which are stored in the history storing part 286, have exceeded the threshold value, outputs the IDs of said wafer holders WH to the notifying part 294 and the drive control part 296.

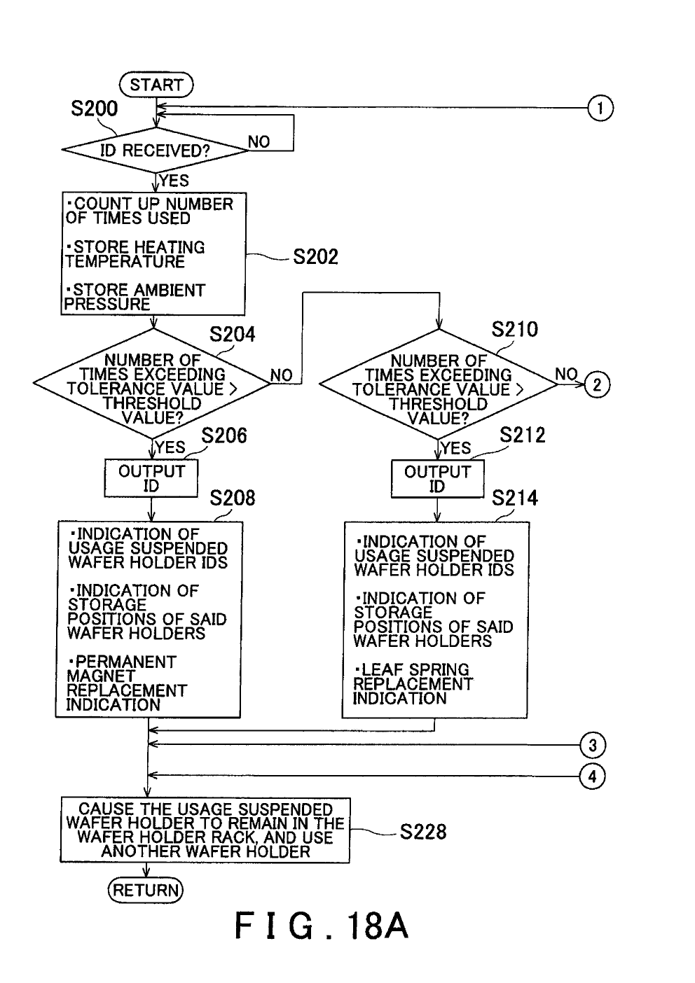

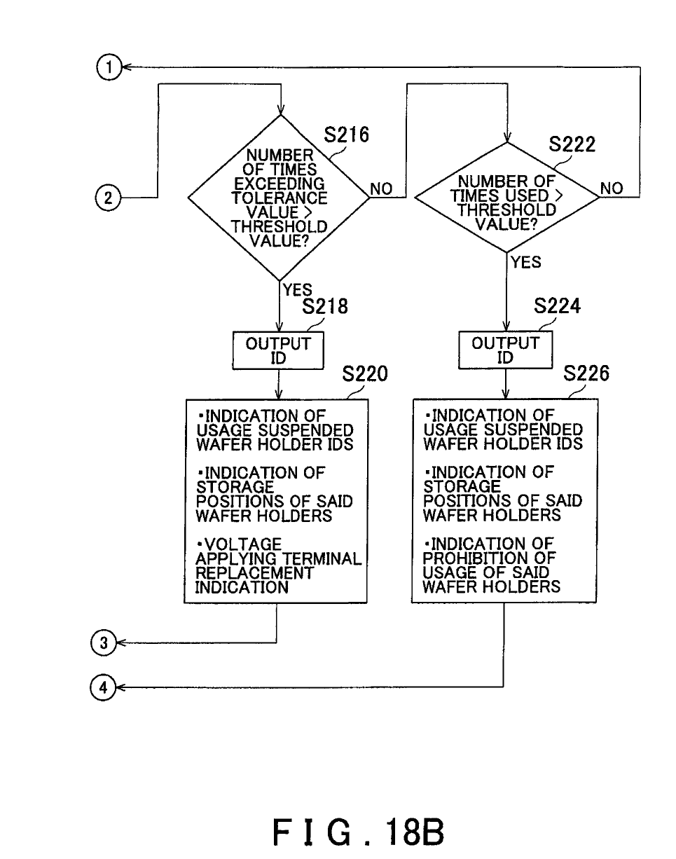

FIG. 18 a flow chart for describing the management method of the wafer holder WH. This flow is started when the power supply of the bonding apparatus 100 is turned on, and there is a shift to step S200. In step S200, the control part 120 makes a determination as to whether or not ID data of the wafer holders WH has been received from the barcode readers 242, and if a positive determination is made, there is a shift to step S202.

In step S202, the history storing part 286 counts up the numbers of times used of the wafer holders WH stored in table 292 in association with the received IDs of the wafer holders WH. In addition, the history storing part 286, in the case in which the heating temperature and ambient pressure information of the wafer holders WH with said IDs has been received from the storage information selecting part 287, counts up the number of times the heating temperatures stored in table 292 have exceeded the first threshold value, the number of times the second threshold value has been exceeded, and the number of times the ambient pressure has exceeded the threshold value.

Next, in step S204, the holding member specifying part 290 makes a determination as to whether or not the numbers of times the heating temperatures stored on the same lines of table 293 as said IDs have exceeded the first threshold value has exceeded the threshold value stored in the deterioration information storing part 288, and if the determination is affirmative, there is a shift to step S206, while if there is a negative determination, there is a shift to step S210.

In step S206, the holding member specifying part 290 outputs said IDs to the notifying part 294 and the drive control part 296, and there is a shift to step S208. In step S208, the notifying part 294 displays on the monitor an indication to the effect that usage of the wafer holders WH with said IDs is to be suspended, the storage positions of said wafer holders WH in the wafer holder rack 150, and an indication that instructs replacement of the permanent magnets 940. Then, there is a shift to step S228.

On the other hand, in step S210, the holding member specifying part 290 makes a determination as to whether or not the numbers of times that the heating temperatures stored on the same lines of table 293 as said IDs have exceeded the second threshold value have exceeded the threshold value stored in the deterioration information storing part 288, and if the determination is affirmative, there is a shift to step S212, while if the determination is negative, there is a shift to step S216.

In step S212, the holding member specifying part 290 outputs said IDs to the notifying part 294 and the drive control part 296, and there is a shift to step S214. In step S214, the notifying part 294 displays on the monitor an indication to the effect that usage of wafer holders WH with said IDs is to be suspended, the storage positions of said wafer holders WH in the wafer holder rack 150, and an indication that instructs replacement of the leaf springs 925. Then, there is a shift to step S128.

On the other hand, in step S216, the holding member specifying part 290 makes a determination as to whether or not the threshold value of the numbers of times the air pressures stored on the same lines of table 293 as said IDs have exceeded the tolerance upper limit value have exceeded the threshold value stored in the deterioration information storing part 288, and if the determination is affirmative, there is a shift to step S218, while if the determination is negative, there is a shift to step S222.

In step S218, the holding member specifying part 290 outputs said IDs to the notifying part 294 and the drive control part 296, and there is a shift to step S220. In step S220, the notifying part 294 displays on the monitor an indication to the effect that usage of wafer holders WH with said IDs is to be suspended, the storage positions of said wafer holders WH in the wafer holder rack 150, and a display that instructs replacement of the voltage applying terminals 930. Then, there is a shift to step S228.

On the other hand, in step S222, the holding member specifying part 290 makes a determination as to whether or not the numbers of times used stored on the same lines of table 292 as said IDs have exceeded the threshold value stored in the deterioration information storing part 288, and if the determination is affirmative, there is a shift to step S224, while if the determination is negative, there is a shift to step S200.

In step S224, the holding member specifying part 290 outputs said IDs to the notifying part 294 and the drive control part 296, and there is a shift to step S226. In step S226, the notifying part 294 displays on the monitor an indication to the effect that usage of wafer holders WH with said IDs is to be suspended, the storage positions of said wafer holders WH in the wafer holder rack 150, and an indication to the effect that discarding of wafer holders WH with said IDs is instructed. Then, there is a shift to step S228.

In step S228, the drive control part 296 controls robot arm 172 so that wafer holders WH with said IDs are not extracted from the wafer holder rack 150, and wafer holders WH with other IDs are extracted from the wafer holder rack 150 and transported to the joining apparatuses 240. With the above, this flow ends.

Specifically, in the present embodiment, in the case in which the number of times the heating temperature of any of the wafer holders WH has exceeded the tolerance temperatures has exceeded the threshold value number of times, the holding member specifying part 290 specifies and outputs the IDs of said wafer holders WH. Then, the drive control part 296 controls robot arm 172 so that wafer holders WH with said IDs are not extracted from the wafer holder rack 150, and wafer holders WH with other IDs are extracted from the wafer holder rack 150 and transported to the joining apparatuses 240. In addition, the notifying part 294 displays on the monitor the IDs of the wafer holders WH whose usage is to be suspended, the storage positions of said wafer holders WH in the wafer holder rack 150, and an indication that instructs replacement of the permanent magnets 940.

Here, the permanent magnets are Al—Ni—Co magnets, and in the case in which heating has been performed a number of times at a temperature that exceeds the tolerance temperature, there are cases in which after thermal demagnetization has occurred, it is not possible to recover the original magnetic force. In this case, as discussed above, there is possibility that it will not be possible to adequately ensure the chucking force of the pair of wafer holders WH and that the pair of wafer holders WH will become misaligned and come out during transport of the wafer holders WH that have interposed the wafers W to the joining apparatuses 240.

However, in the present embodiment, in the case in which the permanent magnets 940 have thermally demagnetized and subsequently have not been able to recover the original magnetic force, usage of wafer holders WH that comprise said permanent magnets 940 is suspended, so it is possible to prevent positional misalignment of the pair of wafers W after alignment adjustment. In addition, the user is able to ascertain, from the display of the monitor, the fact that replacement of the permanent magnets 940 is required, the IDs of the wafer holders WH whose usage has been suspended, and the storage positions of said wafer holders WH in the wafer holder rack 150.

In addition, in the present embodiment, in the case in which the number of times the heating temperatures of any of the wafer holders WH have exceeded the tolerance temperatures has exceeded the threshold value number of times, the holding member specifying part 290 specifies and outputs the IDs of said wafer holders WH. Then, the drive control part 296 controls robot arm 172 so that wafer holders WH with said IDs are not extracted from the wafer holder rack 150, and wafer holders WH with other IDs are extracted from the wafer holder rack 150 and transported to the joining apparatuses 240. In addition, the notifying part 294 displays on the monitor the IDs of the wafer holders WH whose usage is to be suspended, the storage positions of said wafer holders WH in the wafer holder rack 150, and an indication that instructs replacement of the leaf springs 925.

Here, the leaf springs 925 are titanium, and in the case in which heating has been performed a number of times to a temperature that exceeds the tolerance level, there are cases in which, for example, residual warping is released, and embrittlement occurs. In this case, there is a possibility that it will not be possible to perform regulation of chucking of the chucking part 950 well, and accuracy of alignment adjustment of the wafers W will decrease.

However, in the present embodiment, usage of wafer holders WH that comprise the embrittled leaf springs 925 is suspended, so it is possible to restrict reductions in the precision of alignment adjustment. In addition, the user is able to ascertain from the monitor display the fact that replacement of the leaf springs 925 is required, the IDs of the wafer holders WH whose usage has been suspended, and the storage positions of said wafer holders WH in the wafer holder rack 150.

In addition, in the present embodiment, in the case in which the number of times the atmospheric pressures when any of the wafer holders WH have been heated has exceeded the tolerance value has exceeded the threshold value number of times, the holding member specifying part 290 specifies and outputs the IDs of said wafer holders WH. Then, the drive control part 296 controls robot arm 172 so that wafer holders WH with said IDs are not extracted from the wafer holder rack 150, and wafer holders WH with other IDs are extracted from the wafer holder rack 150 and transported to the joining apparatuses 240. In addition, the notifying part 294 displays on the monitor the IDs of the wafer holders WH whose usage is to be suspended, the storage positions of said wafer holders WH in the wafer holder rack 150, and an indication that instructs replacement of the voltage applying terminals 930.

Here, the voltage applying terminals 930 are such that when exposure to the atmosphere in a status in which heating to a high temperature has been performed is repeated a number of times, oxidation occurs, causing conductivity to drop. In this case, there is a possibility that it will not be possible to adequately increase the charging amount of the wafer holders WH, and it will not be possible for the wafer holders WH to adequately ensure an electrostatic chucking function.

However, in the present embodiment, usage of wafer holders WH that comprise the oxidized voltage applying terminals 930 is suspended, so it is possible to restrict falling out of wafers W from the wafer holders WH and the occurrence of positional misalignment of wafers W with respect to the wafer holders WH. In addition, the user is able to ascertain from the monitor display, the fact that replacement of the voltage applying terminals 930 is required, the IDs of the wafer holders WH whose usage has been suspended, and the storage positions of said wafer holders WH in the wafer holder rack 150.

In addition, in the present embodiment, in the case in which the number of times used of any of the wafer holders WH has exceeded the threshold number of times, the holding member specifying part 290 specifies and outputs the IDs of said wafer holders WH. Then, the drive control part 296 controls robot arm 172 so that wafer holders WH with said ID are not extracted from the wafer holder rack 150, and wafer holders WH with other IDs are extracted from the wafer holder rack 150 and transported to the joining apparatuses 240. In addition, the notifying part 294 displays on the monitor the IDs of the wafer holders WH whose usage is to be suspended, the storage positions of said wafer holders WH in the wafer holder rack 150 and an indication that prohibits usage of said wafer holders WH.

Here, the wafer holders WH are subject to pressure application at a high pressure in a status in which heating to a high temperature has been performed, so in the case in which the number of times used has become extremely large, burrs may be produced. However, in the present embodiment, usage of wafer holders WH whose number of times used has exceeded the tolerance value is suspended. In addition, the user is able to ascertain from the monitor display the IDs of the wafer holders WH whose usage has been suspended, the storage positions of said wafer holders WH in the wafer holder rack 150, and the fact that usage of said wafer holders is prohibited.

The present invention has been described above using embodiments, but the technical scope of the present invention is not limited to the scope described in the aforementioned embodiments. In addition, the fact that various changes or improvements may be added to the aforementioned embodiments is clear to persons skilled in the art. Furthermore, the fact that modes to which such changes or improvements have been added can also be included in the technical scope of the present invention is clear based on the descriptions of the scope of the claims.

The fact that the execution sequences of the respective processing such as those of the operations, procedures, steps and stages of the apparatuses, systems, programs and methods indicated in the scope of patent claims, specification and drawings may be realized in any sequence so long as a special explicit statement such as “before” or “in advance” has not been made or the output of previous processes is not used in subsequent processes is to be taken into account. With regard to the operational flow in the scope of patent claims, the specification and the drawings, even if an explanation has been made using “first,” “next,” etc. for convenience, this does not mean that implementation in this order is mandatory.

What is claimed is:

1. A holding member management apparatus, which manages a substrate holding member that holds a semiconductor substrate; comprising
a holding member specifying part, which specifies and outputs the substrate holding member whose usage is to be suspended.

2. A holding member management apparatus according to claim 1; further comprising a conditions storing part, which, with respect to the substrate holding member, stores conditions under which usage is to be suspended, and
the holding member specifying part refers to the conditions storing part and outputs the substrate holding member that satisfies the conditions as the substrate holding member whose usage is to be suspended.

3. A holding member management apparatus according to claim 2; wherein the conditions storing part has a history storing part, which stores the usage history of the substrate holding member in association with identification information that specifies the substrate holding member, and
the holding member specifying part specifies and outputs identification information of the substrate holding member whose usage is to be suspended based on the usage history stored in the history storing part.

4. A holding member management apparatus according to claim 3; wherein the holding member specifying part holds the semiconductor substrate in a manufacturing apparatus that manufactures a stacked semiconductor apparatus by joining a plurality of semiconductor substrates.

5. A holding member management apparatus according to claim 4; wherein the history storing part stores the heat history of the substrate holding member as the usage history.

6. A holding member management apparatus according to claim 5; wherein magnets are attached to the substrate holding member, and
the holding member specifying part specifies and outputs identification information of the substrate holding member whose usage of the magnets is to be suspended based on the heat information stored in the history storing part.

7. A holding member management apparatus according to claim 6; comprising
a deterioration information storing part that stores the threshold value of the heating temperature of the magnets, and
the history storing part stores the heating temperature of the substrate holding member of the manufacturing apparatus as the heat history, and
the holding member specifying part specifies and outputs identification information of the substrate holding member whose usage of the magnets is to be suspended in the case in which the heating temperature stored in the history storing part has exceeded the threshold value stored in the deterioration information storing part.

8. A holding member management apparatus according to claim 6; comprising
a deterioration information storing part that stores the threshold value of the number of times the heating temperature of the magnets has exceeded the tolerance value, and
the history storing part stores the number of times the heating temperature of the substrate holding member has exceeded the tolerance value in the manufacturing apparatus as the heat history, and
the holding member specifying part specifies and outputs identification information of the substrate holding member whose usage of the magnets is to be suspended in a case in which the number of times stored in the history storing part has exceeded the threshold value stored in the deterioration information storing part.

9. A holding member management apparatus according to claim 5; wherein leaf springs are attached to the substrate holding member, and
the holding member specifying part specifies and outputs identification information of the substrate holding member whose usage of the leaf springs is to be suspended based on the heat history stored in the history storing part.

10. A holding member management apparatus according to claim 9; comprising
a deterioration information storing part that stores the threshold value of the heating temperature of the leaf springs, and
the history storing part stores the heating temperature of the substrate holding member of the manufacturing apparatus as the heat history,
and the holding member specifying part specifies and outputs identification information of the substrate holding member whose usage of the leaf springs is to be suspended in the case in which the heating temperature stored in the history storing part has exceeded the threshold value stored in the deterioration information storing part.

11. A holding member management apparatus according to claim 9; comprising
a deterioration information storing part that stores the threshold value of the number of times the heating temperature of the leaf springs has exceeded the tolerance value, and
the history storing part stores the number of times the heating temperature of the substrate holding member has exceeded the threshold value in the manufacturing apparatus as the heat history, and
the holding member specifying part specifies and outputs identification information of the substrate holding member whose usage of the leaf springs is to be suspended in the case in which the number of times stored in the history storing part has exceeded the threshold value stored in the deterioration information storing part.

12. A holding member management apparatus according to claim 5; wherein electrodes are attached to the substrate holding member, and
the holding member specifying part specifies and outputs identification information of the substrate holding member whose usage of the electrodes is to be suspended based on the heat history stored in the history storing part.

13. A holding member management apparatus according to claim 12; comprising
a deterioration information storing part that stores the threshold value of the ambient pressure to which the electrodes are to be heated, and
the history storing part stores the ambient pressure to which the substrate holding member is to be heated in the manufacturing apparatus as the heat history, and
the holding member specifying part specifies and outputs identification information of the substrate holding member whose usage of the electrodes is to be suspended in the case in which the pressure stored in the history storing part has exceeded the threshold value stored in the deterioration information storing part.

14. A holding member management apparatus according to claim 12; comprising
a deterioration information storing part that stores the threshold value of the number of times the ambient pressure to which the electrodes are to be heated has exceeded the tolerance upper limit value, and
the history storing part stores the number of times the ambient pressure to which the substrate holding member is to be heated has exceeded the tolerance upper limit value in the manufacturing apparatus as the heat history, and
the holding member specifying part specifies and outputs identification information of the substrate holding member whose usage of the electrodes is to be suspended in the case in which the number of times stored in the history storing part has exceeded the threshold value stored in the deterioration information storing part.

15. A holding member management apparatus according to claim 5; comprising
a deterioration information storing part that stores the threshold value of the number of times the substrate holding member has been subject to pressure application and heating, and
the history storing part stores the number of times the substrate holding member has been subject to pressure application and heating in the manufacturing apparatus as the heat history, and
the holding member specifying part specifies and outputs identification information of the substrate holding member whose usage is to be suspended in the case in which the number of times stored in the history storing part has exceeded the threshold value stored in the deterioration information storing part.

16. A holding member management apparatus according to claim 4; comprising
a deterioration information storing part that stores the threshold value of the number of times used of the substrate holding member, and
the history storing part stores the number of times that the substrate holding member has been used in the manufacturing apparatus as the usage history, and
the holding member specifying part specifies and outputs identification information of the substrate holding member whose usage is to be suspended in the case in which the number of times stored in the history storing part has exceeded the threshold value stored in the deterioration information storing part.

17. A holding member management apparatus according to claim 4; comprising
an identification information reading part that reads the identification information from an identification indicator provided on the substrate holding member, and
the history storing part stores the usage history of the substrate holding member in association with the identification information read by means of the identification information reading part.

18. A stacked semiconductor manufacturing apparatus; comprising
a joining apparatus, which joins the semiconductor substrates held by the substrate holding member,
a holding member management apparatus according to claim 4, and
a holding member supply part, which supplies a substrate holding member other than the substrate holding member identified by means of the identification information output from the holding member specifying part to the joining apparatus.

19. A holding member management method, which manages a substrate holding member that holds a semiconductor substrate; comprising
a holding member specifying stage, which specifies and outputs the substrate holding member whose usage is to be suspended.

20. A holding member management method according to claim 19; further comprising a
a conditions storage stage that, with respect to the substrate holding member, stores the conditions under which usage is to be suspended in a conditions storing part, and,
in the holding member specification procedure, the conditions storing part is referred to, and the substrate holding member that satisfies the conditions is output as the substrate holding member whose usage is to be suspended.

21. A holding member management method according to claim 20; wherein
the conditions storing part has a history storing part that stores the usage history of the substrate holding member in association with identification information that identifies the substrate holding member, and
in the holding member specification procedure, identification information of the substrate holding member whose usage is to be suspended is specified and output based on the usage history stored in the history storing part.

22. A holding member management method according to claim 21; wherein
the holding member specification procedure controls the substrate holding member that holds the semiconductor substrate in a manufacturing apparatus that manufactures a stacked semiconductor apparatus by joining a plurality of semiconductor substrates.

23. A holding member management method according to claim 22; wherein
the history storage stage includes a stage that stores the heat history of the substrate holding member in the history storing part as the usage history.

24. A holding member management method according to claim 23; wherein
magnets are attached to the substrate holding member, and
the holding member specifying stage includes a stage that specifies and outputs identification information of the substrate holding member whose usage of the magnets is to be suspended based on the heat history stored in the history storing part.

25. A holding member management method according to claim 24; comprising
a deterioration information storage stage that stores the threshold value of the heating temperature of the magnets in the deterioration information storing part, and
the history storage stage includes a stage that stores the heating temperature of the substrate holding member in the history storing part in the manufacturing apparatus as the heat history, and
the holding member specification stage includes a stage that specifies and outputs identification information of the substrate holding member whose usage of the magnets is to be suspended in the case in which the heating temperature stored in the history storing part has exceeded the threshold value stored in the deterioration information storing part.

26. A holding member management method according to claim 24; comprising
a deterioration information storage stage that stores the threshold value of the number of times that the heating temperature of the magnets has exceeded the tolerance value in the deterioration information storing part, and
the history storage stage includes a stage that stores the number of times that the heating temperature of the substrate holding member has exceeded the tolerance value in the history storing part in the manufacturing apparatus as the heat history, and
the holding member specification stage includes a stage that specifies and outputs identification information of the substrate storing member whose usage of the magnets is to be suspended in the case in which the number of times stored in the history storing part has exceeded the threshold value stored in the deterioration information storing part.

27. A holding member management method according to claim 23; wherein
leaf springs are attached to the substrate holding member, and
the holding member specification stage includes a stage that specifies and outputs identification information of the substrate holding member whose usage of the leaf springs is to be suspended based on the heat history stored in the history storing part.

28. A holding member management method according to claim 27; comprising
a deterioration information storage stage that stores the threshold value of the heating temperature of the leaf springs in the deterioration information storing part, and
the history storage stage stores the heating temperature of the substrate holding member in the history storing part of the manufacturing apparatus as the heat history, and
the holding member specification stage includes a stage that specifies and outputs identification information of the substrate holding member whose usage of the leaf springs is to be suspended in the case in which the heating temperature stored in the history storing part has exceeded the threshold value stored in the deterioration information storing part.

29. A holding member management method according to claim 27; comprising
a deterioration information storage stage that stores the threshold value of the number of times the heating temperature of the leaf springs has exceeded the tolerance value in the deterioration information storing part, and
the history storage stage includes a stage that stores the number of times that the heating temperature of the substrate holding member has exceeded the tolerance value in the history storing part in the manufacturing apparatus as the heat history, and
the holding member specification stage includes a stage that specifies and outputs identification information of the substrate holding member whose usage of the leaf springs is to be suspended in the case in which the number of times stored in the history storing part has exceeded the threshold value stored in the deterioration information storing part.

30. A holding member management method according to claim 23; wherein electrodes are attached to the substrate holding member, and
the holding member specification stage includes a stage that specifies and outputs identification information of the substrate holding member whose usage of the electrodes is to be suspended based on the heat history stored in the history storing part.

31. A holding member management method according to claim 30; comprising
a deterioration information storage stage that stores the threshold value of the ambient pressure to which the electrodes are to be heated in the deterioration information storing part, and
the history storage stage includes a stage that stores the ambient pressure to which the substrate holding member is to be heated in the history storing part in the manufacturing apparatus as the heat history, and
the holding member specification stage includes a stage that specifies and outputs identification information of the substrate holding member whose usage of the electrodes is to be suspended in the case in which the pressure stored in the history storing part has exceeded the threshold value stored in the deterioration information storing part.

32. A holding member management method according to claim 30; comprising
a deterioration information storing part that stores the threshold value of the number of times that the ambient pressure to which the electrodes are to be heated has exceeded the tolerance upper limit value, and
the history storage stage includes a stage that stores the number of times that the ambient pressure to which the substrate holding member is to be heated has exceeded the tolerance upper limit value in the history storing part in the manufacturing apparatus as the heat history,
and the holding member specification stage includes a stage that specifies and outputs identification information of the substrate holding member whose usage of the electrodes is to be suspended in the case in which the number of times stored in the history storing part has exceeded the threshold value stored in the deterioration information storing part.

33. A holding member management method according to claim 23; comprising
a deterioration information storage stage that stores the threshold value of the number of times that the substrate holding member has been subject to pressure application and heating in the deterioration information storing part, and
the history storage stage includes a stage that stores the number of times that the substrate holding member has been subject to pressure application and heating in the history storing part in the manufacturing apparatus as the heat history, and
the holding member specification stage includes a stage that specifies and outputs identification information of the substrate holding member whose wage is to be suspended in the case in which the number of times stored in the history storing part has exceeded the threshold value stored in the deterioration information storing part.

34. A holding member management method according to claim 22; comprising
a deterioration information storage stage that stores the threshold value of the number of times used of the substrate holding member in the deterioration information storing part, and
the history storage stage includes a stage that stores the number of times used of the substrate holding member in the history storing part of the manufacturing apparatus, and
the holding member specification stage includes a stage that specifies and outputs identification information of the substrate holding member whose usage is to be suspended in the case in which the number of times used stored in the history storing part has exceeded the threshold value stored in the deterioration information storing part.

35. A holding member management method according to claim 22; comprising
an identification information reading stage that reads the identification information from an identification indication provided in the substrate holding member, and
the history storage stage includes a stage that stores the usage history of the substrate holding member in the history storing part in association with the identification information read in the identification information reading stage.
